(19) United States
(12) Patent Application Publication
(10) Pub. No.: US 2002/0025802 A1
(43) Pub. Date: Feb. 28, 2002

(54) Method for broadcasting and restitution of messages

(76) Inventor: Bertrand Dupuis, Paris (FR)

Correspondence Address: NILLES & NILLES, S.C., INTELLECTUAL PROPERT ATTORNEYS, FIRST CENTER, SUITE 2000, 777 EAST WISCONSIN AVENUE, MILWAUKEE, WI, 53202-5345, US

(21) Appl. No.: 09/791,164

(22) Filed: Feb. 22, 2001

(30) Foreign Application Priority Data
Feb. 22, 2000 (FR) 00 02209

(51) Int. Cl. H04M 3/00

(52) U.S. Cl. 455/419; 455/466; 455/422

(57) ABSTRACT

The disclosed method enables a network of message senders to send imposed messages to mobile electronic devices connected to one or more cell telecommunications networks, discreetly, in a way that is not cumbersome for the user of the targeted device, and costs little in terms of occupancy of the communications network being exploited. Furthermore, the message senders' network sends its messages through a cell telephony network, and more particularly through the data channels of this network. The imposed message is stored in a specific memory of the electronic device considered. It can thus be restituted several times to the output units of the electronic device in having been transmitted only once in the device. Means are proposed to manage the restitution of the imposed message thus stored.

### BACKGROUND OF THE INVENTION

1. Field of the Invention

The invention relates to a method for the broadcasting and restitution of a message from a cell telecommunications network to a set of mobile telephone or mobile electronic organizer type electronic communications devices. The types of messages broadcast according to the method of the invention are essentially advertising, entertainment or information messages prepared by networks of message senders. The messages concerned are therefore in no way designed for the setting up or progress or terminating of a telephone call through the cell communications network considered. They are secondary to the technical aspect of making the connection. These messages are called imposed messages because they are not necessarily chosen by the person who receives them. They are distinct from messages known as functional messages, which play a role in the functioning of a telecommunications call. The nature of the imposed messages broadcast is variable. These may be simple text, images, video animation, sound, tunes any other form of message suitable for broadcasting.

In general, the field of the invention is that of mobile telecommunications. It is aimed at giving message senders' networks the possibility of broadcasting the object of their advertisements to a wide public which, furthermore, may be selected according to certain criteria.

2. Description of the Prior Art

In the prior art, there are known methods of broadcasting imposed messages used by message senders' networks, making use of modern telecommunications means. Thus, for example, when a user gets connected to the Internet, access to certain sites is necessarily accompanied by a downloading of data that corresponds to imposed messages sent by message senders' networks who find a means here of reaching a wide public. These messages are therefore downloaded simultaneously with information proper to the site to which the user wishes to get connected. The downloading of information proper to the site is therefore slowed down by the transfer of these imposed messages. For reasons related to the financing of the sites, these imposed messages often appear first on the screen, contrary to the users' wishes. Furthermore, access to another site leads to another downloading of new imposed messages, once again slowing down data exchanges. It may even happen that identical imposed messages are associated with two different sites. Yet, the passage from one site to another will entail the downloading of the imposed message in question and, therefore, a further slowing down in the access to the information sought. Indeed, these messages are never stored in the device accessing the Internet, whether it is a personal computer or a portable telephone that can communicate with a cell radiotelephony network connected to the Internet or a mobile organizer. Each display of the imposed message therefore follows a data transmission that has encumbered the telecommunications network. Furthermore, access to a site necessarily leads to the appearance of a predefined imposed message that does not depend on the identity of the interlocutor.

In the prior art, there also exist known message senders' networks who use a cell radiotelephony network to send predefined imposed messages through the speech transmission channel at regular intervals. Thus, for example, the imposed message concerned is broadcast and restituted through a loudspeaker or a screen of the electronic communications device at regular intervals. Here too, the message thus restituted comes directly from the remote communications network and in no case from the electronic device used. Therefore, the broadcasting of these messages is relatively cumbersome for a user of the electronic device on which they are restituted because they disturb the communication that has been set up. It is also costly in terms of broadcasting on the communications network being exploited because the imposed message has to be sent again for each new restitution in the electronic device considered. Furthermore, the management of the sending and restitution of such messages is a difficult operation.

The method according to the invention is used to resolve all the problems that have just been explained. The method according to the invention enables a network of senders of imposed messages to send messages to mobile electronic devices connected to one or more cell telecommunications networks, without the knowledge of the user of the electronic device, that is to say discreetly, in a way that is not cumbersome for the user of the targeted device, and costs little in terms of occupancy of the communications network being exploited. Furthermore, the message senders' network sends its messages through a cell telephony network and more particularly through the data channels of this network. Thus, in the particular case of a mobile telephone, the message may be downloaded as soon as the telephone is located by a base station, namely as soon as it is connected to the telecommunications network without in any way being in a operational mode of operation but, possibly, in what is called a standby mode. According to the invention, the imposed message thus transmitted is stored in a specific memory of the electronic device considered. The imposed message may thus be restituted several times to output organs of the electronic device while having been transmitted only once to the device. Means to manage the restitution of the imposed message thus stored are proposed in an implementation of the method according to the invention. These means of restitution may be accompanied by means of acknowledgment of reception and/or means of acknowledgment of message restitution on one of the output elements of the electronic device considered. Furthermore, the network of senders of imposed messages may consult a database of a cell radiotelephony operator to make a preliminary determination of a particular public liable to be interested in these messages and thus choose to broadcast said messages only to the electronic devices of selected users.

### SUMMARY OF THE INVENTION

The invention therefore relates to a method for the broadcasting and restitution of a message in mobile communications electronic devices, said message being imposed, wherein the method comprises the steps of:

preparing the imposed message;

introducing the imposed message into an appropriate communications network of the cell radiotelephony network type;

sending the imposed message to the mobile communications electronic device of a user, through the appropriate communications network, without the knowledge of a user of said device;

storing the imposed message in a specific memory of the electronic device;

restituting, on loudspeaker type and/or screen type output elements, the imposed message contained in the specific memory of the device at instants subsequent to the transmission of said message and following certain events detected on the mobile electronic device, defined by a set of parameters contained in the message and/or in the mobile communications electronic device.

Furthermore, the messages are transmitted by data channels of the communications network. These data channels are for example two-way short message service (SMS) channels or unstructured supplementary service data (USSD) channels used to convey data by a network or again switched or packet mode data transmission channels.

In a preferred mode of implementation of the invention, the appropriate communications network may exchange data with the Internet. Various modes of restitution of messages through the output elements of the electronic device considered are proposed.

### BRIEF DESCRIPTION OF THE DRAWING

The invention will be understood more clearly from the following description and the appended figure.

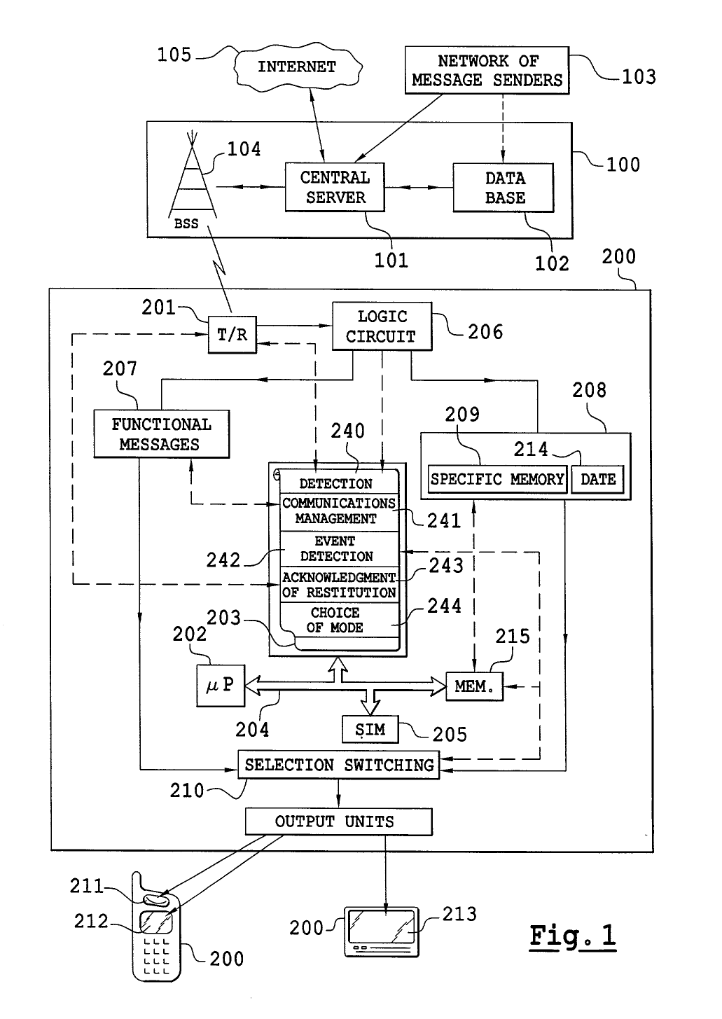

This FIG. 1 is given purely by way of an indication and in no way restricts the scope of the invention. The figure is a simplified diagram of a communications system used to implement the method according to the invention.

### MORE DETAILED DESCRIPTION

This figure shows a cell radiotelephony network 100 managed by a particular operator on a specific territory. This network is called a PLMN (public land mobile network). It may be seen as a mobile communications system providing radio access to the general network, the PSTN (public switched telephone network). A PLMN organizes the distribution of specific equipment the fulfils the need for itinerancy (the user of a radiotelephony network moving at different points of the territory covered should be capable of calling and being called) and the notion of intercell transfer (the requirement of ensuring the continuation of the service while the user is moving). In the PLMN 100, there is especially a central server 101 managing a set of databases dedicated to the working of the network. Among these databases, a subscriber database 102 stores data on all the subscribers of the network as well as, if necessary, some characteristics of these subscribers. An entity 103 corresponding to a message senders' network may, with the agreement of the operator of the PLMN 100, prepare imposed messages and transfer them to the central server 101 for broadcasting. Furthermore, with the agreement of the operator to whom the PLMN 100 belongs, the message senders' network may access the database 102.

Connection to the Internet 105 is also envisaged from the PLMN 100. Communications between the PLMN 100 and a mobile electronic communications device 200 is provided by a radio subsystem 104 called a BSS (base station subsystem) consisting of a base station controller (BSC) and a base transceiver station (BTS). The base station controller controls one or more BTSs and manages the radio resource, especially by making a channel allocation for each call and managing the decisions on intercell transfer. The BTS is a piece of equipment consisting of radio transceiver units. It forms the interface between the mobile electronic communications devices and the BSC.

The electronic device 200 will be described in the case where it corresponds to a mobile telephone type of mobile station. The invention however can be applied to other devices that may communicate with the PLMN 100, such as for example mobile organizers. Mobile organizers can be likened to communication terminals dedicated especially to the consultation and dispatch of Internet messages. One of their characteristics is a screen 213 whose size is suited to the reception of lengthy text or images.

The mobile station 200 comprises a transceiver unit 201 that can be used especially to receive signals sent from the BSS 104. A microprocessor 202 of the mobile terminal 200 is connected to a program memory 203 by means of a two-way communications bus 204. The program memory has several applications, dedicated to the implementation of the method according to the invention, that may be replaced by specialized electronic circuits. The microprocessor manages all the operations of transmission, reception, encoding, decoding and all the other services proposed in the electronic device considered. Address, data and control information elements are conveyed between the microprocessor and the different electronic elements of the mobile terminal through the two-way communications bus 204. For the sake of simplifying the figure, not all the connections of the bus 204 are shown. They are replaced in the figure by links indicating the main transfers of information that come into play, during the implementation of the method according to the invention, in the mobile telephone 200. The microprocessor especially may exchange information with a SIM (subscriber identity module) card 205. A SIM card is a card that is inserted into a mobile terminal and contains a set of information elements about the subscription. Preferably, the SIM card considered in the mobile telephone 200 is a proactive SIM card that can send control instructions to the terminal.

The transceiver unit 201 is connected to a logic circuit 206 whose essential function is to route arriving messages to a unit 207 for processing functional messages or to a unit 208 for processing messages known as imposed messages. The processing unit 208 furthermore comprises a memory 209 to store imposed messages. The two processing units 207 and 208 are connected to a selection switching device 210 used to select the type of message that has to be sent to message restitution units of the electronic device considered. These restitution units or output units may be a loudspeaker 211, a screen 212 of the mobile terminal or the screen 213 of the mobile organizer. When the imposed restituted message is a text, it may for example appear as a scrolling message in a reserved region of the screen.

An exemplary implementation of the method according to the invention is now presented in detail. The first step of the method of broadcasting a message according to the invention consists of the preparation of the message. This operation is performed by the message senders' network 103 who, in line with an agreement made with the operator managing the PLMN 100, may choose to broadcast the message to a target that may be either all the subscribers of the operator or a certain number of subscribers who are selected according to the criteria contained in the database 102. The message to be sent is encoded in binary form and stored in the central server 101. The broadcasting to all the targeted mobile stations is done by the BSS 104. The imposed messages thus broadcast are received by the transceiver unit 201 of the mobile station 200.

Through a detection application 240 of the program memory 203, the logic circuit 206 sends the received message to the processing unit 208 when it is an imposed message or to the processing unit 207 when it is a functional message. The detection application 240, to this end, analyzes a header of the message received. This header contains especially information used to determine whether it is a functional message or an imposed message. The detection application 240 also has the function of storing the time and date of reception of an imposed message. These information elements are stored in a memory 214 of the processing unit 208 or may be exploited especially in the step of restitution of the message. The imposed messages for their part are stored in the specific memory 209.

The specific memory 209 may as the case may be contain several imposed messages. In another embodiment, the specific memory may contain only one imposed message. In the latter example, when a new imposed message is received by the mobile station 200, it may either automatically replace the earlier imposed message contained in the specific memory 209 or not replace it unless the former imposed message has been sent to the restitution organs of the device 200 a certain number of times and during a period that is determined beforehand.

Another function of the detection application 240 is that it sends back an acknowledgment message to the PLMN 100 through the data channels of the communications network. This acknowledgment message may possibly contain a piece of information indicating whether the new imposed message has been stored in the specific memory 209 or whether it was not possible to store it because of the presence of a former imposed message which had not been restituted in the conditions planned for it. However, certain imposed messages may have a character of priority and replace the preceding message. This message is then erased or repositioned to complete its cycle of restitution after the priority imposed message has completed its own cycle. A hierarchy of imposed messages contain the specific memory 209 may thus be set up if the specific memory 209 can contain several imposed messages. This hierarchy is set up by analyzing information that may be contained in the header of each imposed message reaching the mobile telephone 200.

A communications management. application 241 of the program memory 203 manages the usual processing of the functional messages in the processing unit 207.

An event detection application 242 of the program memory 203 activates the restitution of an imposed message contained in the specific memory 209 at certain points in time or depending certain actions performed on the mobile telephone 200. The events that may be detected and are the object of event-related restitution are for example:

the reception of a telephone call. This event may for example lead to the restitution of the imposed message on the restitution device of the electronic device considered, for example in the form of a message, a still or animated cartoon on the screen 212, or in the form of a tune through the loudspeaker 211. The tune corresponding to the imposed message may thus indicate the arrival of a call. Thus, at each new call and/or for a predetermined number of calls, the mobile telephone will ring differently, according to a ring sent by the message senders' network. The usefulness of performing a restitution of the message imposed on the screen 212 following the reception of a call is that it almost is certain that the user will look at his mobile telephone in the seconds that follow the reception of the call;

a downloading of data from the Internet. In this case, throughout the duration or during a part of the duration of the downloading, the imposed message may be restored on the screen 212 or through the loudspeaker 211 during the user's waiting time. The restitution of the imposed message during the downloading does not slow down the downloading. Indeed, the imposed message that is restituted is already contained in the electronic communications device 200. Its restitution does not therefore encumber the communications network exploited;

pressure on a particular key, for example a key of the telephone, is used to pass into hands-free mode. In this case, while the mobile communications terminal is used in hands-free mode, the imposed message of the specific memory 209 may be restituted during a part of the communication or throughout the communication on the screen 212. Here again, the restitution of the message following this event is judicious because there is a high probability that the user will look at his mobile terminal. The detected event may also correspond to pressure on a key other than the one used to pass into hands-free mode. This key may be any of the keys commonly present in the keypads of mobile terminals.

The imposed messages may also be restituted at regular predetermined time intervals and/or during a limited predetermined duration. The limiting of the restitution time may apply as much to the time for which a restitution lasts as to the period during which the imposed message is permitted to remain in the specific memory 209, possibly independently of the priority nature of the imposed message considered. Beyond this predefined duration of conservation in the memory, the specific memory is automatically erased. These restitutions, known as time-related restitutions as opposed to event-related restitutions which have been presented, use the event detection application 242 which uses information contained in the memory 214 pertaining to the date and time of arrival of the message in the mobile telephone 200. The parameters pertaining to the mode of restitution of the imposed messages, namely the duration of a restitution, the duration of retention in memory, the frequency of restitution, the number of maximum reiterations of restitution of one and the same message, the event leading to the restitution, the determining of the output element at which the message is restituted, are for example stored in a memory 215 of the mobile telephone 200. These information elements may possibly be introduced or updated by the proactive SIM card 205 or by data elements contained in the header of the binary message encoding the imposed message. The parameters pertaining to the mode of restitution are thus information elements that can be parametrized and modified. The priority nature of the imposed message is an information element preferably contained in the header of the binary message encoding the imposed message.

An acknowledgment of restitution application 243 is used to automatically return an information element to the network 100 at each restitution of the imposed message of the memory 209. This information takes the form of a restitution acknowledgment message transmitted by the data channels of the communications network. The network of senders of the message considered may thus be able to assess the frequency of restitution of its messages. A piece of information pertaining to the identification of the user and/or the mobile electronic device that acknowledges the restitution of the imposed message may also be sent. The piece of acknowledgment information is sent from the mobile telephone 200 to the network 100 through the cell radiotelephony network data channels that had been used for the transmission of the imposed message.

An application 244 of the choice of the mode enables the user to implement the method according to the invention. Should the user accept the operations of transmission of imposed messages to his mobile terminal and their restitution through his output units, he may for example benefit from a subsidy for his calls from the message senders' network 103. The modalities of this subsidy could take a multitude of forms. The application 244 of the choice of modes enables the implementation of a preliminary step of proposing, to the user, a mode of subsidy of calls implemented simultaneously with the method according to the invention.

The method according to the invention can also be implemented in the context where the message senders' network has been selected by the user of the electronic communications device. The imposed messages in this case may be information elements, for example sports results or recent stock exchange quotations. In this context, it is a user who is likely to pay a subscription to the message senders' network concerned. The steps of transmission, storage and restitution may be implemented as here above.

What is claimed is:

1. A method for the broadcasting and restitution of a message in mobile communications electronic devices, said message being imposed, wherein the method comprises the steps consisting in:
preparing the imposed message;
introducing the imposed message into an appropriate communications network of the cell radiotelephony network type;
sending the imposed message to the mobile communications electronic device of a user, through the appropriate communications network, without the knowledge of a user of said device;
storing the imposed message in a specific memory of the electronic device;
restituting, on loudspeaker type and/or screen type output elements, the imposed message contained in the specific memory of the device at instants subsequent to the transmission of said message and following certain events detected on the mobile electronic device, defined by a set of parameters contained in the message and/or in the mobile communications electronic device.

2. A method for the broadcasting and restitution of a message according to claim 1, wherein the parameters defining the instants and the events determining the restitution of an imposed message can be updated.

3. A method for the broadcasting and restitution of a message according to one of the above claims, wherein the messages are transmitted by data channels of the communications network.

4. A method for the broadcasting and restitution of a message according to one of the above claims, wherein the appropriate communications network can exchange data with the Internet.

5. A method for the broadcasting and restitution of a message according to one of the above claims, wherein the step of restitution of the imposed message is carried out while the electronic communications device is being used in “hands free” mode.

6. A method for the broadcasting and restitution of a message according to claim 4, wherein the step of restitution of the imposed message is performed during a downloading of data from the Internet.

7. A method for the broadcasting and restitution of a message according to one of the above claims, wherein the step of restitution of the imposed message consists of the scrolling display of said message in a reserved zone of the screen.

8. A method for the broadcasting and restitution of a message according to one of the above claims, wherein the step of restitution of the imposed message is carried out in the form of a tune at each call arriving in the mobile communications device.

9. A method for the broadcasting and restitution of a message according to one of the above claims, wherein the step of storage of an imposed message has the effect of replacing an old imposed message by a new imposed message.

10. A method for the broadcasting and restitution of a message according to one of the above claims, wherein the specific memory is automatically erased at the end of a period of time predefined by the parameters contained in the stored imposed message and/or in the electronic mobile communications device.

11. A method for the broadcasting and restitution of a message according to one of the above claims, wherein the step of restitution of the imposed message is limited in duration.

12. A method for the broadcasting and restitution of a message according to one of the above claims, wherein the step of restitution of a stored message is reiterated a certain number of times.

13. A method for the broadcasting and restitution of a message according to one of the above claims, comprising the additional step of acknowledging, by means of a reception acknowledgment message sent by the mobile electronic communications device, of each storage of an imposed message in the specific memory, the reception acknowledgment message being transmitted by data channels of the communications network.

14. A method for the broadcasting and restitution of a message according to one of the above claims, comprising the additional step of acknowledging, by means of a reception acknowledgment message sent by the electronic communications mobile, of each restitution of the imposed message contained in the specific memory on the output elements of the electronic device, the restitution acknowledgment message being transmitted by data channels of the communications network.

15. A method for the broadcasting and restitution of a message according to claim 14, wherein the restitution acknowledgment message contains a piece of information on the identification of the user and/or the mobile electronic device.
